(19) United States
(12) Patent Application Publication
(10) Pub. No.: US 2004/0158637 A1
(43) Pub. Date: Aug. 12, 2004

(54) Gated-pull load balancer

(76) Inventor: Timothy Charles Lee, Davis, CA (US)

Correspondence Address: Tim Lee, Unit N, 38 Fort Mason, San Francisco, CA, 94123, US

(21) Appl. No.: 10/365,172

(22) Filed: Feb. 12, 2003

(51) Int. Cl. G06F 15/16; G06F 15/173

(52) U.S. Cl. 709/226; 709/229

(57) ABSTRACT

A method of serving work requests received from one or more clients (105), where the work requests identify a specific server system and a specific type of work to be completed. Work requests and server-availability notifications are stored in the server system. Work requests are sent to a plurality of parallel-connected server units (100) in response to the receipt of availability notifications from server units (100) and a manager unit (106) determining expected performance of a server unit (100) matches load balancing criteria, and the server unit (100) is capable of processing the work request.

### BACKGROUND

1. Field of the Invention

This invention is in the field of high-availability server computer devices capable of providing the same type of functionality to a large number of client computer devices.

### BACKGROUND

2. Description of Prior Art

Computer networks are frequently utilized to serve a large number of requests originating from a plurality of clients.

A ‘network’ of computers can be any number of computers that are able to exchange information with one another. The computers may be arranged in any configuration and may be located in the same room or in different countries, given there is some way to connect them together (for example, by telephone lines or other communication systems) so they can exchange information. Just as computers may be connected to form a network, networks may also be connected together through tools known as bridges and gateways.

Balancing a load amongst a plurality of servers connected by a network has proven to be an important and complex task; many means to balance a load have been proposed.

U.S. Pat. No. 6,0237,22 to Colyer issued Feb. 8, 2000 discloses a system where client requests are queued and servers pull these requests from a queue as servers become available. A disadvantage of the disclosed system becomes apparent when servers have different capabilities. For instance, given there are two identical work requests in a queue and two servers are available, one of the servers processing work requests three times faster than the second of the servers. Optimally the faster server will handle both requests. However, in the disclosed system each server would handle one work request.

U.S. Pat No. 6,279,001 to DeBettencourt, et al. issued Aug. 21, 2001 discloses a load-balancing process based on load metrics of server machines. In the disclosed process the probability of a server being picked to handle a work request is proportional to its load metric. This method has two clear disadvantages. First, its reliance on a “randomly” distributed load means that when a work request queue length is short, there is a high probability that the load will be misbalanced. Second, it has a dependence on random number generators. Every random number generator has occasional regularities that can cause a dependent application to fail.

U.S. Pat. No. 6,377,975 to Florman issued Apr. 23, 2002 discloses a system where load is distributed to servers with the lowest reported load. However, this type of load balancer suffers from drawbacks in that the load balancer only checks the status of each server device on a periodic basis. A particular server deemed to be not busy at one instance of time when the load balancer checks may be very busy at a later time in between status checks. In such instances a particular server device can be assigned too much work and respective clients would wait longer than necessary for a task to be completed.

### OBJECTS AND ADVANTAGES

An object of the present invention is to provide a load sharing control method and apparatus in which a load for a plurality of work types can be assigned to a plurality of computers constituting a computer group in accordance to each computer's performance rating.

Another object of the present invention is to provide a load sharing control technique in which a load can be shared among a plurality of computers constituting a computer group correspondingly to the respective characteristics of work types.

A further object of the present invention is to provide a load sharing control technique in which a load can be shared efficiently when a load for a plurality of work types is assigned to a plurality of computers constituting a computer group.

According to one aspect, the gated-pull load balancer provides a method of serving requests received from a plurality of client computer devices via a computer network. Each of the requests specifically identifies a specific server system. This method comprises the steps of: a manager unit storing, at the specific server system, the received requests; and the manager unit allocating the requests to a plurality of parallel-connected server units.

Since servers are assigned work requests only as they become available as opposed to a load balancer “pushing” requests onto servers without servers asking for such requests. The server system and thus the overall client/server system thus work much more efficiently to serve client work requests. Moreover the load balancer prevents slower service programs from serving work requests in a case where another service program would more efficiently serve the requests. Further, the load balancer directs work requests only to servers capable of servicing the work requests, and has no dependence on random number generators.

Other objects, features and advantages of the gated-pull load balancer will become apparent when reading the following detailed description of the embodiments of the invention in conjunction with the accompanying drawings.

### BRIEF DESCRIPTION OF THE DRAWING

FIG. 1 is a block diagram of an embodiment of a gated-pull load balancer according to the present invention.

FIG. 2 is a flowchart of processing that occurs when an embodiment of a manager of FIG. 1 attempts to allocate work requests to agents of FIG. 1.

FIG. 3 is a flowchart of the processing that triggers allocation of work requests to servers of FIG. 1.

### REFERENCE NUMERALS IN DRAWINGS

100 server

101 agent

102 service program

103 manager

104 performance database

105 client

106 manager unit

### SUMMARY

A process to efficiently allocate load to a plurality of networked computers of varying capabilities.

### DETAILED DESCRIPTION OF THE PREFERRED EMBODIMENTS

A system for serving work requests has a plurality of servers and a system for balancing load amongst the servers. The system can collect performance data on service programs running on the servers and can use the data to efficiently balance load across the plurality of servers.

An embodiment of the present invention will be described below in detail with reference to accompanying drawings. In all drawings for explaining the embodiment, parts having the same as or equivalent to each other are referenced correspondingly and repetition of description is omitted.

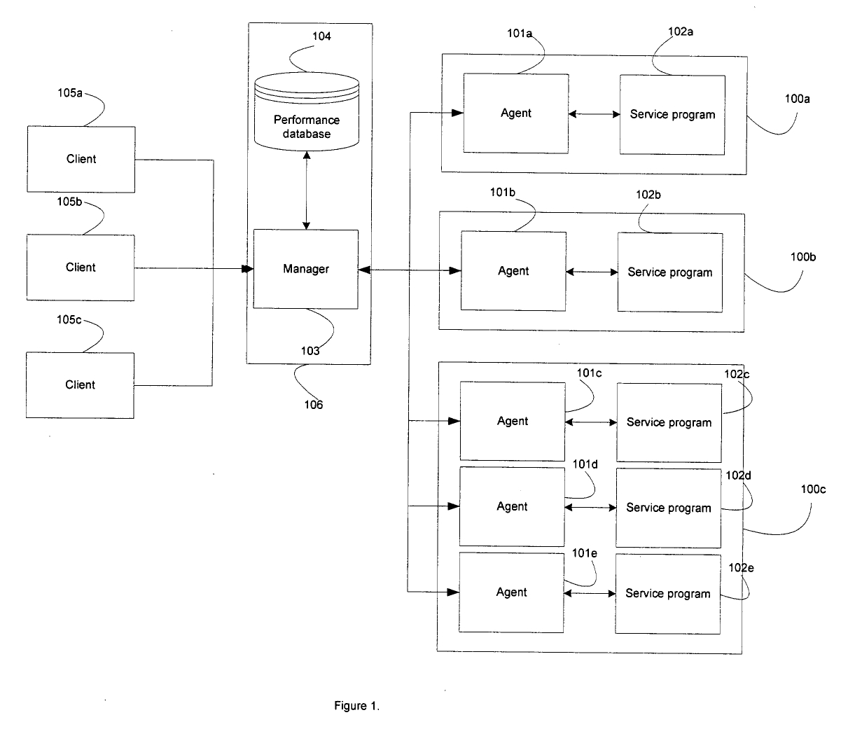

Referring to FIG. 1, various components 100-105 of a gated pull load balancer can communicate over one or more computer networks. Physical location of the components 100-105 does not impact the capability or the performance of the system, as long as the communications links between various components have sufficient data communication capability.

The gated-pull load balancer FIG. 1 manages one or more servers 100. Three servers 100a-100c are shown as an example. An embodiment of the gated-pull load balancer can have any number of servers 100. Each server 100 can be a computer system commercially available and capable of using a multithreaded operating system such as UNIX or Windows XP. Each server can have at least one network connection to a computer network, for example the Internet, which allows the server 100 to service work requests in response to clients 105 issuing work requests. Each server 100 includes at least one service program 102.

A service program 102 can be any program that performs a function in response to input, such as a Java compiler program. In this context, a work request might be a request to compile a Java source file into a Java byte code file (usually referred to as a class file).

Although a plurality of service programs 102 may be identical, the server 100 running a service program 102 would affect performance of each of the service programs 102. For example, if three identical Java compilers were running on three unique servers 100, performance of each of the compilers would be affected by performance capabilities of the server 100 running the compiler.

The gated-pull load balancer can be configured so that subsets of service programs 102 exclusively service a particular type of work requests. In one embodiment all work requests to compile Java source files are directed to Java compilers running on Windows XP servers 100, while all work requests to compile UNIX C++ source code are directed to UNIX C++ compilers running on UNIX servers 100.

A server 100 can have any number of service programs 102 running on it depending on capacity, performance, and cost considerations. In one embodiment, a server 100a includes one service program 102a. In another embodiment, a server 100c includes three service programs 102c-e. Note that one service program 102a on server 100a and three service programs 102c-e on server 100c are meant to serve as illustrative example and not meant to limit the number of potential service programs 102 running on a server 100.

A single server 100 can make available a plurality of service programs 102 of different types via agents 101. For example a single server 100 may make available an RCS source control service program 102 via one agent 101 and a Java compiler version 1.4 service program 102 via a second agent 101.

An agent 101 provides a service program 102 interface to a server 100. An agent 101 links a service program 102 to a manager 103. In the preferred embodiment there is one agent 101 for each service program 102.

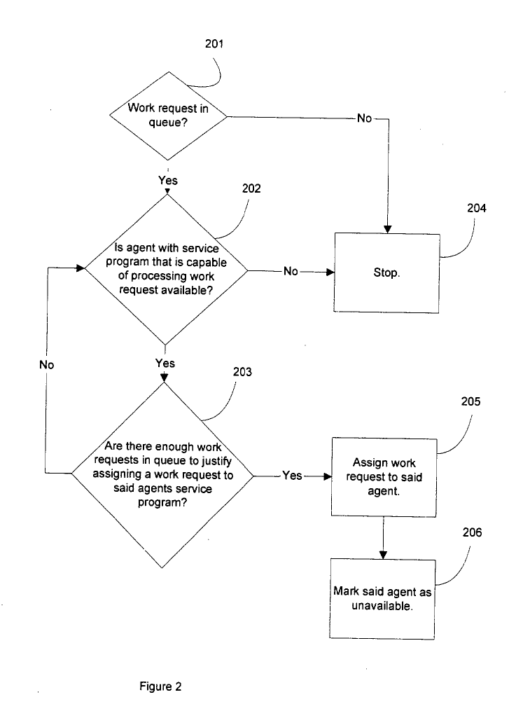

Each agent 101 communicates with a manager 103 running on a manager unit 106. Each manager unit 106 can be a computer system commercially available and capable of using a multithreaded operating system such as UNIX or Windows XP. A manager 103 receives information from an agent 101 about the status of service programs 102a-e and/or servers 100a-c. A manager 103 queues work requests from clients (step 307) and sends commands to agents 101a-e to service a work request (step 205). Allocation logic is pictured in FIG. 2. A manager 103 can track performance of each service program 102 through an agent 101 and can use the performance information to update a performance database 104 (step 304). Information in a performance database 104 is used to efficiently balance load on each service program 102 and server 100 (step 203).

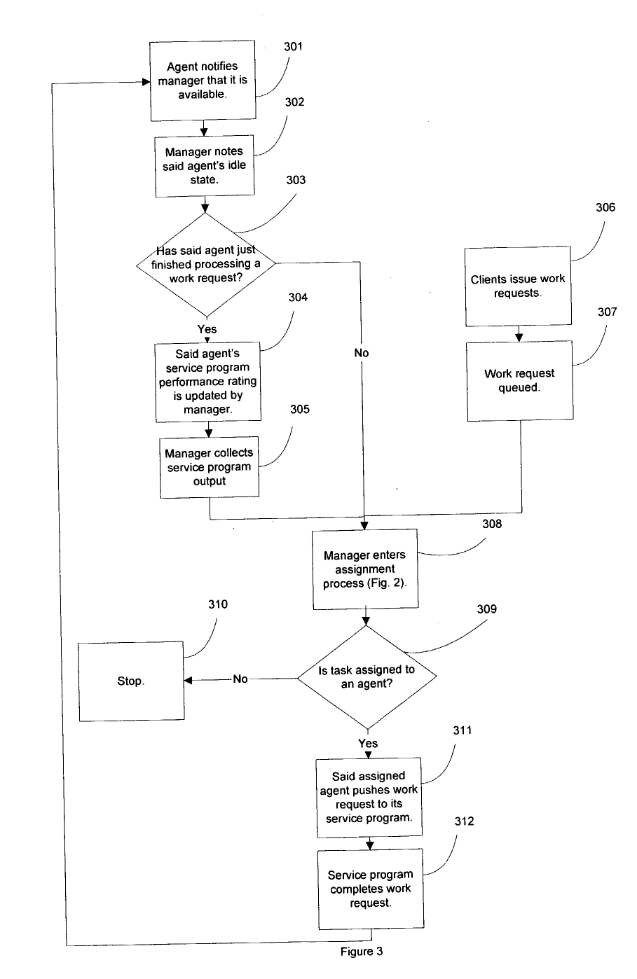

Referring to FIG. 3, which is a flowchart of the processing that triggers allocation of work requests to servers. A manager 103 attempts to allocate work requests when it 103 receives an availability notification from an agent 101 or when it 103 receives a new work request from a client 105 (step 306).

In the preferred embodiment a manager 103 tracks all service program 102 performance and uses such information to efficiently balance load over multiple servers 100.

Each agent 101 monitors a service program 102. Agents 101 notify a manager 103 that a service program 102 is ready to receive work requests (step 301). That is when a service program 102 has already finished serving a work request and is sitting idly (step 312); its agent 101 asks for another work request to serve by sending an availability notification to a manager 103 (step 301). The same applies for other service programs 102, and agents 101. If a service program 102 matches type (step 202), and load balancing criteria (step 203), the manager 103 assigns a work request to the service program 102 via an agent 101 (step 205). This can be thought of as a “gated pull” model, since service programs 102 attempt to pull work requests from a queue as they 102 become available (step 301). A manager 103 blocks a pull request of service programs 102 which do not meet load-balancing criteria (step 203). This process has an advantage that it will not overload service programs 102 because any service program 102 assigned a work request must have issued an availability notification, and it efficiently balances load amongst faster and slower service programs 102.

In the preferred embodiment an agent 101 receives a work requests from a manager 103 (step 205), pushes the work request to its service program 102 (step 311), notifies its manager 103 when the work request has been processed by its service program 102 (step 301), and returns any output of the service program 102 resulting from the work request back to the manager 103 (step 305).

Matching Work Request to Service Program 102 of Appropriate Type

Each work request contains a type identifier: the identifier specifies which type of work is being requested to be completed. For example one type identifier may specify “compile using Sun Java compiler 1.2.1 for Windows NT” another may specify “compile using Microsoft visual C++ 5.0 on Windows NT”.

An agent 101 makes available the type identifier of its service program 102. By matching each work request's type identifier to an agent's 101 type identifier, the gated-pull load balancer assures that work requests are always processed on a server 100 capable of correctly processing the work requests.

In the preferred embodiment there is a unique queue for each type of work request. Agents 101 and thus service programs 102 are assigned work requests from the queue of work requests matching their type.

Blocking Service Program 102 pull Request.

Load balancing is achieved through a gated-pull mechanism. An idle service program's 102 agent 101 will ask for a work request from the work request queue matching the agent's 101 type. However the agent's manager 103 blocks some pull requests from the agent 101 when the manager determines that a work request would be better serviced by an alternative service program 102.

A service program's 102 performance rating is used to determine if it 102 is allowed to pull a work request from a work request queue. Service programs 102 can be given a performance rating relative to the fastest service program 102. For purposes of illustration, service programs 102 are Java compilers; work requests are requests to compile Java source code. If service program A 102 performs compilation of Java files on average nine times as fast as service program B 102, service program A 102 would have a performance rating of 1 and service program B 102 a performance rating of 9. A service program s 102 is not allowed to pull work requests from the work request queue matching the service programs type whenever the following criteria is met:

l<Pₛ,

where l is number of work requests in the queue and Pₛ is performance rating of service program s 102.

In the above example, service program A 102 would never be blocked from pulling a work request from the work request queue (so long as there were a work request in the work request queue to pull), while service program B 102 would be blocked whenever the number of work requests in the queue was less than nine (step 203).

Service Programs 102 Performance Rating.

A service programs 102 performance rating is proportional to its mean time to process a work request. This can be determined by tracking performance on every work request or merely a representative sample thereof (step 304). In the preferred embodiment performance ratings are normalized to the fastest average work request completion time for a given type of work request. For example, two service programs 102 are Java compilers. The faster compiler (compiler A) takes five seconds on average to compile a source file, and the slower Java compiler (compiler B) takes 45 seconds on average to do the same. The performance ratings would be calculated as follows

$${P}_{B} = \frac{45}{5} , {P}_{A} = \frac{5}{5} .$$

For the general case the performance ratings are

$${P}_{s} = \frac{{T}_{s}}{{T}_{f}} ,$$

where T_{f} is the fastest average work request completion time, and Tₛ is the average work request completion time for service program s 102.

Performance ratings can be determined independently for each type of work request. For example, a work request to retrieve a copy of a file from RCS source control may run slowly on a server 100 because it has a slow IO device. However a work request to compile source code may be processed quickly on the server 100 due to its high performance CPU.

In one embodiment the performance rating is adjusted such that performance on more recent work requests is more heavily weighted. This can be useful if a service program's 102 performance is expected to change at certain times, for example when system backup or disk defragmentation is taking place on the server 100 where the service program 102 is running. At such a time, performance of the service program 102 is likely to deteriorate. An example of simple linear weighting function for service program 102 performance is

$${P}_{s} = \frac{\sum \frac{1}{e} {P}_{st}}{\sum \frac{1}{e}} ,$$

where Pₛₜ is the performance rating for service program s during time interval t and e is average elapsed time for Pₛₜ. For example a Pₛₜ might be calculated every two minutes. If for service program A 102 the last 5 Pₛₜ were 8, 2,2,2,2, and average elapsed time for each of these were 1,3,5,7, and 9 minutes respectively

$${P}_{A} = \frac{\frac{1}{1} 8 + \frac{1}{3} 2 + \frac{1}{5} 2 + \frac{1}{7} 2 + \frac{1}{9} 2}{\frac{1}{1} + \frac{1}{3} + \frac{1}{5} + \frac{1}{7} + \frac{1}{9}} = 5.35 .$$

In this example mean performance ratings are estimated over time interval t. Mean performance over each time interval is weighted by mean elapsed time since the sample was taken. In this fashion, more recent performance samples more heavily influence a performance rating. After performance ratings are updated, they are renormalized to the fastest performance rating. In this fashion, the fastest performer would always have a performance rating of 1.

This example is used for purposes of illustration. Many other linear or nonlinear types of weighting could be used.

Although this embodiment shows the case where the number of computers constituting a group of computers is four, it is a matter of course that said invention is not limited thereto and that any desired number of computers may be provided.

Although the present invention has been described above specifically on the basis of an embodiment, it is a matter of course that the invention is not limited to the embodiment and that various modifications or changes may be made without departing the gist of the invention.

Conclusions, Ramifications, and Scope

The disclosed load balancing process has an advantage that it will not overload a server 100 because service programs 102 are assigned a work request only after they notify a manager 103 of their availability. The load balancer will also efficiently balance load over a plurality of servers 100 of differing performance in both high and low volume situations. Further, work requests of various types will always be directed to servers 100 capable of processing such work requests. Finally, the disclosed load balancer does not use a random number generator to distribute load.

Although the description above contains much specificity, this should not be construed as limiting the scope of the invention but as merely providing illustrations of some of the presently preferred embodiments of this load balancer. For example, if service programs can interface with a manager directly, agents may not be necessary; in another embodiment, agents 101 may interface with more than one service program 102; in another embodiment, a manager 103 may run on the same computer as an agent 101 or service program 102.

In one embodiment if there is a problem with a service program 102, the service program's agent 101 or manager 103 marks the service program 102 as unavailable (and the manager recalculates any relative performance ratings). Therefore the service program 102 will no longer be assigned any work requests.

In one embodiment performance rating is a static value that can be assigned by a system operator.

In some cases it may be advantageous to allow service programs 102 to pull multiple work requests from the queue with a single pull request, in such a case a useful blocking criteria is

l<nPₛ,

where n is the number of work requests pulled in a single pull request. This simple blocking criterion is most effective when n<l. In one embodiment if a pull request for n work requests is blocked, a pull for n-1, n-2 . . . 1 is subsequently attempted.

In one embodiment performance ratings are rounded to integers.

In one embodiment additional servers 100 may be activated if the queue length for work requests exceeds some threshold number.

In one embodiment work requests of all types are collected in a single physical queue that is segregated into virtual queues for each type of work request. In this embodiment 1 represents the length of the appropriate virtual queue.

In one embodiment a service program may return the result of a work request directly back to the client

In one embodiment a client may submit a plurality of work requests simultaneously.

Thus the scope of the invention should be determined by the appended claims and their legal equivalents, rather than by the examples given.

1. A computer server system which serves work requests from one or more computer client devices connected through a network to said server system, said server system comprising:
a manager unit having an input connected to a network upon which said requests identifying said server system are received, a means to send work requests to available service programs of correct type and appropriate expected speed, and an output; and
a plurality of server units connected in parallel to said output of said manager unit, wherein each server unit notifies manager unit of its availability.

2. The system of claim 1 wherein said manager unit includes means for sending a work request to one of said plurality of server units in response to said server unit informing said manager unit that said server unit is ready to serve a request and said manager unit determining said server unit matches load balancing criteria and said server unit is capable of processing said work request.

3. A method of serving work requests received from one or more client computer devices via a network, each of said work requests specifically identifying a specific server system and a specific type of work request, said method comprising steps of:
storing, at said specific server system, said received work requests; and storing at said specific server system server unit availability notifications; and
sending said work requests to a plurality of parallel-connected server units in response to the receipt of availability notifications from said server units and a manager unit determining expected performance of said server unit matches load balancing criteria, and said manager unit determining said server unit is capable of processing said work request.
